(19) United States
(12) Patent Application Publication
(10) Pub. No.: US 2025/0116590 A1
(43) Pub. Date: Apr. 10, 2025

(54) Apparatus and Method for Measuring a Parameter of Particles

(71) Applicant: Dyneval Limited, Edinburgh (GB)

(72) Inventor: Vincent Martinez, Edinburgh (GB)

(21) Appl. No.: 18/833,227

(22) PCT Filed: Jan. 25, 2023
(86) PCT No.: PCT/GB2023/050161

§ 371 Date: Jul. 25, 2024

(30) Foreign Application Priority Data
Jan. 26, 2022 (GB) 2200974.0
Nov. 25, 2022 (GB) 2217670.5

(51) Int. Cl. G01N 15/0227; G01N 15/10; G01N 15/1433; G06T 7/00

(52) U.S. Cl. CPC G01N 15/0227; G01N 15/1433; G06T 7/0012; G01N 2015/1006; G06T 2207/10004; G06T 2207/20056; G06T 2207/30024

(57) ABSTRACT

A portable device for measuring at least one parameter of particles in solution, the portable device including: a light source; a camera comprising an imaging sensor for generating digital images; an optical system comprising at least one objective lens and/or an objective and/or a lens and/or a combination of lenses, and a sample holder, wherein a sample comprises the particles in solution; wherein the imaging sensor and/or camera has a frame rate of greater than 100 frames per second, preferably, greater than 200 frames per second, more preferably, greater than 290 frames per second, even more preferably, greater than 300 frames per second.

### FIELD

The present invention relates to an apparatus and method for measuring at least one parameter of particles, particularly, particles in solution.

### BACKGROUND

Dairy farmers are losing money each year due to poor conception rates in cattle, which have fallen by 20% over the past 40 years. Current methods for semen assessment used on farm generate errors >10% for standard semen concentrations and mainly rely on visual assessment. Across the industry there is no user-independent quality control standard for vets, farmers and AI technicians to check semen quality before reproduction.

It is desired to find a method to help farmers raise conception rates to improve the profitability of farming while reducing the carbon footprint of dairy and meat products. It is also desired to find improved methods for semen assessment for humans (e.g. studying human fertility in IVF clinics) and other animals (including sheep, horse, pig, goats, fish, poultry, dogs and all cattle).

### SUMMARY

According to a first aspect of the invention, there is provided: a portable device for measuring at least one parameter of particles in solution, the portable device comprising: a light source; an imaging means (e.g. imaging sensor) for generating images (e.g. digital images); an optical system comprising at least one objective lens and/or an objective and/or a lens and/or a combination of lenses, and a sample holder.

According to a second aspect of the invention, there is provided: a system comprising: a portable device and remote processing unit for measuring at least one parameter of particles in solution, the portable device comprising: a light source; an imaging means (e.g. imaging sensor) for generating images (e.g. digital images); an optical system comprising at least one objective lens; a sample holder, and means for transferring the images (e.g. digital images) to the remote processing unit.

The device may comprise a processing unit for processing and/or configured to process the digital images. The remote processing unit may be for processing and/or configured to process the digital images.

The processing unit and/or remote processing unit may comprise a Central Processing Unit (CPU) and a Graphical Processing unit (GPU). The processing unit and/or remote processing unit may provide a processing resource for automatically or semi-automatically processing the digital images. The processing unit and/or remote processing unit may comprise a single circuitry (e.g. a suitable processing circuitry) or a plurality of circuitries. In embodiments, the circuitry or circuitries may be each implemented in the CPU and/or GPU by means of a computer program having computer-readable instructions that are executable to perform a method of the embodiment. In other embodiments, the circuitry or circuitries may be implemented as one or more ASICs (application specific integrated circuits) or FPGAs (field programmable gate arrays) or other suitable dedicated circuitry. A computing apparatus may comprise the processing unit and/or remote processing unit. The computing apparatus, the processing unit and/or the remote processing unit may also include a hard drive and other components of a PC including RAM, ROM, a data bus, an operating system including various device drivers, and hardware devices including a graphic card. Whilst particular circuitries may be used, in embodiments functionality of one or more of these circuitries can be provided by a single processing resource or other component, or functionality provided by a single circuitry can be provided by two or more processing resources or other components in combination. Reference to a single circuitry encompasses multiple components providing the functionality of that circuitry, whether or not such components are remote from one another, and reference to multiple circuitries encompasses a single component providing the functionality of those circuitries. Embodiments, or features of such, can be implemented as a computer program product for use with a computer system, the computer program product being, for example, a series of computer instructions stored on a data recording medium, such as a disk, CD-ROM, ROM, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device. It will also be well understood by persons of ordinary skill in the art that whilst embodiments implement certain functionality by means of software, that functionality could be implemented solely in hardware or by a mix of hardware and software. As such, embodiments are not limited only to being implemented in software.

The processing unit and/or the remote processing unit may be for processing, be configured to process and/or comprise at least one pre-stored processing routine. The pre-stored processing routine may be for obtaining the at least one parameter. The pre-stored processing routine may be configurable by a user. The at least one processing routine may comprise analysing the power spectrum of the difference between pairs of the spatial Fourier transform of the digital images separated by a time delay over a range of time delay and spatial Fourier frequency. It is the difference between two images in a pair (not the difference between pairs) which is then calculated for all pairs or subsection of all the pairs of Fourier images. The time delay is the time difference between two images within a pair, not the time difference between pairs.

The obtaining of the at least one parameter may be by carrying out Differential Dynamic Microscopy (DDM). The processing unit and/or the remote processing unit may be for carrying out and/or be configured to carry out Differential Dynamic Microscopy (DDM). DDM may be carried out over all pairs of images and q values or a subsection of all the pairs of images and/or a subsection of all the q values.

The obtaining of the at least one parameter may be by processing the digital images. The obtaining of the at least one parameter may be by analysing (and/or calculating) Fourier transforms of (a plurality of) the digital images. The obtaining of the at least one parameter may be by analysing (and/or calculating) a spectrum (e.g. power spectrum). The obtaining of the at least one parameter may be by analysing (and/or calculating) a spectrum (e.g. power spectrum) of the difference between a plurality (e.g. pairs) of the (e.g. spatial) Fourier transform of (a plurality of) the digital images. The digital images may be separated by a time delay, e.g. over a range of time delay and/or spatial Fourier frequency.

Analysing the (e.g. power) spectrum of the difference between pairs of the (e.g. spatial) Fourier transform of the digital images, e.g. separated by a time delay over a range of time delay and/or spatial Fourier frequency, may comprise: (1) calculating the differential image correlation function (DICF), e.g. calculating the spatial Fourier transform of the images and then calculating the power spectrum of the difference of pairs of the Fourier images, e.g. over a range of accessible delay time tau (i.e. time difference between two selected images) and/or spatial frequency (q) provided by the Fourier transform of the images. All possible pairs of Fourier images or a selection of pairs of Fourier images may be considered. The calculation may be carried out over all possible, or a subsection of, pairs of Fourier images. The method may further include (2) then averaging all resulting DICF which has the same delay time (tau) together. The method may further include (3) then performing a radial average for each q values, e.g. yielding the final time-averaged and vector{q}-averaged DICF, e.g. as a function of delay time tau and/or spatial frequency q. All possible q values or a selection of q values may be considered. The calculation may be carried out over all possible, or a subsection of, q values.

The optical system and imaging sensor may be configurable or configured such that the pixel size in the image is and/or is selectable from a range of 0.1 micron/pixel to 10.0 micron/pixel, preferably 0.5 micron/pixel to 7 micron/pixel, even more preferably, 2 to 7 micron/pixel, 3 to 6 micron/pixel, 4 to 5 micron/pixel, 4 to 4.5 micron/pixel, 4.10 to 4.30 micron/pixel, 4.15 to 4.25 micron/pixel, 4.2 to 4.35 micron/pixel, 4.25 to 4.35 micron/pixel, greater than 2.65 micron/pixel and less than 7 micron/pixel, greater than 2.65 micron/pixel and less than 7.04 micron/pixel, greater than 2 micron/pixel and less than 2.65 micron/pixel. The pixel size in the image may be 2 micron/pixel, 4.2 micron/pixel, 4.3 micron/pixel, or 7 micron/pixel. It will be appreciated that the pixel sizes in image may be considered to be substantially and/or approximately the values indicated. The values for the pixel sizes in image may not be exactly as stated. For example, they may be within +/−5% of the value. This may be due to e.g. tolerances in design for manufacturing and/or variability in manufacturing.

The optical system and imaging sensor may be configurable or configured such that the q value for DDM is 0.05 μm⁻¹ to 0.4 μm⁻¹ or any subset of this range tailored to the species, for example 0.2 μm⁻¹ to 0.4 μm⁻¹ for bull spermatozoa. Other parameters may be extracted from different ranges of q values. Q values may depend on both the pixel size in the image and the size of the images in pixels.

The device and/or system may comprise a camera. The camera may comprise the imaging sensor. The imaging sensor and/or the camera may capture digital image and/or video.

The pixel size in the image may be dependent on several factors, e.g. the pixel size in the imaging sensor, the optical system set up (e.g. the optical components such as the objective lens or other lens, and the positions between the optical components in the optical system, including the imaging sensor), and how the imaging sensor (or more particularly the camera including the imaging sensor) is operated, e.g. the binning mode used or set.

The device and/or the system may comprise a means for displaying the at least one parameter of particles in solution. The means for displaying the at least one parameter of particles in solution may be a screen or a printer for generating a paper report.

The device and/or system may include a means for user interaction (such as button) to (e.g. automatically) perform the data collection and/or data analysis. The data collection and/or data analysis may be automated to produce the measurement of the parameter of the particles. The data collection and/or data analysis may be performed through a single user interaction, such as a click of a button (more generally, the means for user interaction). Data collection and/or data analysis of measurements (such as a sequence of measurements) through time (e.g. for a number of hours, such as up to 12 hours) may be collected automatically through a single user interaction, such as a click of a button.

The device and/or system may be preconfigured to provide the desired pixel size in the image. That is, one or more of the factors that result in a particular pixel size in the image may be arranged or set such that the pixel size in the image is set to have a predetermined range or value.

The at least one objective lens may comprise an objective, a lens or a combination of lenses.

The at least one objective lens and/or other components of the device and/or optical system may be associated with one or more processing routines.

The at least one objective lens may comprise at least one optical property. The at least one optical property may be magnification, field of view, depth of field, focal length. The at least one optical property may be associated with providing the desired pixel size in the image.

The optical system may comprise at least two objective lenses. The at least two objective lenses may have at least one different optical property. The at least two objective lens may each have different magnifications. One of the objective lenses may be for allowing images to be captured for DDM processing (e.g. to measure the micro-organism motility). The other of the objective lenses may be for visual inspection of the particles (e.g. to visualise particles in solution at a resolution at which a head of the micro-organism is visible). As an example, this may be in a range of 5 to 15 pixels in size in the image but this will depend on the final pixel size in the image and thus the combination of the objective lens or lens combination with how the camera is operated (e.g. 1×1 or 2×2 binning). The other of the objective lens may be used for e.g. smaller microorganisms (e.g. bacteria) and/or colloidal particles.

The objective lens may have a magnification such that a head of a micro-organism is in a range of 1 to 5 pixels or less than 1 pixel in size in the image.

The objective lens may have a focal length of 15 cm. The objective lens may have a focal length of less than 15 cm. This may allow the device to be made more compact.

The objective lens or lenses may have a magnification in a range of 1× to 4× (e.g. for spermatozoa), in a range of 5× to 10× (e.g. for bacteria such as E-coli), in a range of 5× to 20× (e.g. for micro-algae), and/or in range of 5× to 50× for colloids.

The optical system may comprise a means for reflecting the light from the objective lens to the imaging sensor. The optical system may comprise a mirror. The mirror may be between the at least one objective lens and the imaging sensor. The mirror may have an advantage that the components of the device may fit into a stable and conveniently sized housing or box. If there is no mirror, then all the light from the light source to the imaging sensor may go in a single straight line. Having a mirror to break the distance from the light source to the imaging sensor into 2 parts which are not in a straight line may allow a more compact device. The at least one objective lens may require a distance of approximately 30 cm between the light source and the imaging sensor. The mirror may break that distance into 2×15 cm parts for example.

The optical system may comprise a means for refracting and/or focusing the light from the objective lens to the imaging sensor. The optical system may comprise a further lens between the at least one objective lens and the imaging sensor. More particularly, the further lens may be between the mirror and the imaging sensor. The further lens may be referred to as a tuning lens. The further lens may allow fine tuning of the final pixel size in the image and/or par-focal imaging. Par-focal imaging means that the same part of the sample is imaged (approximately) when switching from two different objective lens.

The imaging sensor may comprise a pixel size in a range of 0.5 to 10 microns/pixel, more preferably 2 to 7 microns/pixel, even more preferably 2 to 5 microns/pixel, 3 to 6 micron/pixel, 4 to 5 micron/pixel. The imaging sensor may comprise a pixel size of 4.8 microns. It will be appreciated that this pixel size of the imaging sensor is different from the pixel size in the image. For example, if the total optical setup provides a 10× magnification, then the pixel size in the image=0.1*the pixel size of the imaging sensor. The values for the pixel size in the imaging sensor may not be exactly as stated. For example, they may be within +/−5% of the value.

The device and/or system may comprise a means for running in different binning and/or skipping modes. The imaging sensor and/or camera may be configured to be run in different binning and/or skipping modes. For example, to be run in 1×1, 2×2, and 4×4 binning mode. This may allow the desired pixel range in the image to be set, e.g. so that DDM may be carried out for spermatozoa using one objective lens and visual imaging of the spermatozoa may be carried out using the other objective lens. The camera may have a driver that allows binning. Binning may be carried out at the camera or post-processing after the images have been captured and/or video has been recorded. “Binning” may be considered to allow combinations of pixels to become one pixel while “skipping” skips pixels to reduce the image resolution.

The imaging sensor and/or camera may have a frame rate of greater than 50 frames per second, preferably, greater than 100 frames per second, more preferably greater than 200 frames per second, even more preferably greater than 300 frames per second. In embodiments, the imaging sensor and/or camera may have a frame rate of greater than 290 frames per second. In embodiments, the imaging sensor and/or camera may have a frame rate up to at least one of: 500; 600; 700; 800; 900; 1000; 10,000; 100,000; 1,000,000 frames per second. As an example, the imaging sensor and/or camera may have a range of frame rate of 300 to 800 frames per second. It will be appreciated that this is just an example, and there may be ranges comprising any applicable lower and upper limits mentioned. More particularly, it may be considered that the imaging sensor having a frame rate means the electronics around/with the imaging sensor having or setting the frame rate. The camera may be considered to have or set the frame rate. The frame rate may be a desired and/or predetermined frame rate. The digital images and/or video may be recorded (e.g. by the processing unit or remote processing unit) at the (selected) frame rate. The processing unit or remote processing unit may be for or may be configured to process and/or record the digital images and/or video at the desired predetermined frame rate. The camera may operate at the desired predetermined frame rate and the videos may be recorded at the desired predetermined frame rate. There may be some fluctuations in exact frame rate, e.g. within perhaps 1%. For example, if the frame rate wanted is 300 fps, the final and true frame rate of the recorded images may fluctuate approximately between 297 fps and 303 fps across a video. It may be considered that, e.g. a frame rate of 300 fps is most preferred (i.e. ideal) as other lower frame rates (such as using a frame rate at 200 fps) may struggle to apply the technology to all species or wide range of sample. However, it will be appreciated that other frame rates would work, e.g. 290 fps. The frame rates mentioned may be considered to be substantially or approximate frame rates. The frame rate that an imaging sensor and/or camera can deliver may depend on the size of the images (in pixel). For example, a frame rate of 300 frames per second or greater than 300 frames per second may be achieved with an image size of e.g. 512×512 pixels or 328×328 pixels. It will be appreciated that these image sizes are just examples and other different image sizes may be used for particular frame rates. The frame rate of greater than 300 frames per second may be with a field of view (image size) of at least 300×300 pixels (+/−5%), or more preferably at least 328×328 pixels (+/−5%). The frame rate of greater than 100 frames per second may be with a field of view (image size) of at least 512×512 pixels (+/−5%). The frame rate of greater than 200 frames per second may be with a field of view (image size) of at least 300×300 pixels (+/−5%), or more preferably at least 328×328 pixels (+/−5%). The frame rate of greater than 290 frames per second may be with a field of view (image size) of at least 300×300 pixels (+/−5%), or more preferably at least 328×328 pixels (+/−5%). For example, an imaging sensor and/or camera may be able to do a maximum of 500 frames per second with a field of view (image size) of at least 512×512 pixels (+/−5%). As another example, an imaging sensor and/or camera may be able to do a maximum of 800 frames per second with a field of view (image size) of at least 328×328 pixels (+/−5%). It will be appreciated that other imaging sensors and/or cameras may be able to have higher frame rates than these for the same or different image sizes and, at least theoretically, there is no upper limit to frame rate. Generally, relatively higher frame rate cameras are more expensive than relatively lower frame rate cameras. As an example, if recording for 30 s at e.g. 600 fps, then technically there will be double amount of images compared to 300 fps. Therefore, bigger video size and many more images to process and thus longer processing time and computer RAM required. However, a 600 fps video could be recorded, but only the equivalent of 300 fps images may be used to process, which would help solve the issue of longer processing time.

The pixel size in the image may be the size of the part of the sample that is imaged per pixel. The pixel size in the image represents what the pixel ‘sees’ in the true sample. For example, if there is a feature of 10 microns in the sample, and the pixel size in the image is 1 micron, then this feature will appear over approximately 10 pixels in the image. The pixel size in the image may be considered to be the resolution (i.e. the shortest distance between two points on a sample that may be distinguished by the device and/or system as separate entities or discrete units). The pixel may be considered to be a discrete unit. The pixel size in the image may be referred to as the size of the part of the sample that is imaged per discrete unit that may be distinguished, processed or displayed.

The pixel size in the image may be greater than 2.65 micron/pixel and/or less than 7.04 micron/pixel (e.g. for spermatozoa). Having a pixel size in the image at and/or between 2.65 micron/pixel and 7.04 micron/pixel may work for measuring at least one parameter for e.g. spermatozoa but not all the pixel sizes in the image in the range may be optimal. There may be an optimal pixel size and/or range of pixel size in the image between 2.65 micron/pixel and 7.04 micron/pixel. The device and/or system may be configurable and/or configured to provide the optimal pixel size and/or range of pixel size in the image for specific particles that are desired to be measured. The device and/or system may be configurable and/or configured such that the pixel size and/or range of pixel size in the image provides a balance between having a large enough field of view for statistical analysis and a range of q values for efficiency of the DDM analysis and/or such that the magnification is not too large such that, when using another objective lens, then visual imaging of the particles is more difficult or not possible (i.e. the magnification is such that, when using another objective lens, visual imaging of the particles is possible, and is not too difficult.) (These pixel size and/or range of pixel size in the image may be considered optimal).

The pixel size in the image may be substantially and/or approximately 4.3 micron/pixel. It may be considered that the pixel size in the image is 4.3+/−5% micron/pixel. This may have an advantage of providing a balance between having a large enough field of view for good statistics and the right range of q values for optimal efficiency of the DDM analysis. 2.65 micron/pixel may give lower adequate q values over which the technique works and the field of view would be 4× smaller when compared with 4.3 micron/pixel when using the same number of image pixels. This may yield potentially less accurate measurements and to get a similar field of view may require a relatively higher number of pixels which may then cause issues to process the videos efficiently e.g. on a low specification laptop. For microorganisms bigger than spermatozoa, 2.65 micron/pixel may still work but again may not be optimal for similar reasons as above. 7.04 micron/pixel means that the higher magnification would also be significantly bigger when compared to using 4.3 micron/pixel and thus observation of individual cell and flagellum of spermatozoa may not be possible.

The pixel size in the image may be substantially and/or approximately 0.9, 1.7, 2.1 and/or 4.3 micron/pixel. 0.9, or more specifically 0.86, micron/pixel allows imaging of flagellum (e.g. approx. 1 micron thick) of spermatozoa and/or micro-algae. 4.3 micron/pixel allows DDM to be carried out for spermatozoa and/or micro-algae. 0.9, 1.7 and/or 2.1 micron/pixel allows DDM to be carried out for bacteria. 0.9 micron/pixel may allow DDM to be carried out for colloidal particles. It may be considered that the values of pixel size in the image are within +/−5% of the value. These example pixel sizes in the image may provide a balance between having a large enough field of view for good statistics and the right range of q values for optimal efficiency of the DDM analysis.

The at least one parameter of particles may be considered to be a parameter characterising particles.

The device and/or system may be for measuring a plurality of parameters of particles in solution and/or parameters characterising particles in solution.

The at least one parameter may include motility of the particles, preferably, percentage motility, mean speed, concentration, size, amplitude of head movement, rate of diffusion and/or frequency of head movement. More generally, fluctuations of the intensity in the images may be characterised. The processing unit and/or remote processing unit may be for characterising and/or configured to characterise the fluctuations of the intensity in the images (e.g. using DDM). The imaging sensor and/or camera is for detecting fluctuations of the intensity of light transmitted through the particles in solution. Characterising the fluctuations of intensity in the images may be considered to be collecting intensity fluctuations (e.g. by detecting the intensity fluctuations using the imaging sensor and/or camera) and processing the images (e.g. using DDM) to obtain the measurements.

The particles may be micro-organisms.

The micro-organisms may range in size from bacteria to micro algae.

The micro-organisms may be bacteria, spermatozoa, and micro algae. Bacteria may have a size of approximately 0.1 micron to 5 microns, spermatozoa may have a size of approximately 1 micron to 10 microns, and micro-algae may have a size of approximately 2 microns to 15 microns.

The particles may be colloids or colloidal particles. They may have a size of 0.05 microns to 3 microns, more preferably 0.1 microns to 3 microns, more generally, sizes ranging from tens of nanometers to micrometers. The particles may be droplets (e.g. milk fat droplets), and/or emulsions.

A sample may comprise particles in solution. A sample holder may be for holding a sample (e.g. on a sample slide).

The device may be configurable and/or configured such that light from the light source is transmitted to the sample holder without undergoing refraction. The device may not comprise a condenser lens. The device may be configured such that light from the light source is incident on the sample in the sample holder without the light being refracted. The light may be incident directly on the sample in the sample holder. This has the advantage that the device may be made physically smaller and lighter (i.e. more portable or easier to move). Standard microscopes include a condenser to focus light into the objective lens. This is because microscopes are intended to use high magnifications which requires more light. A condenser lens is not required in the present device as it is based on lower magnification and thus does not require high illumination. Avoiding the use of the condenser lens does not adversely affect the imaging and analysis but allows a reduction of the overall height of the device.

The light source may be an LED. The LED may be located in a LED holder. The LED may be any colour. The LED may be preferably green. This may be for brightfield imaging of the sample.

The device may be at least partially enclosed in a housing (e.g. a box). The device and/or the box may have dimensions of less than 40×30×20 cm. The device and/or the box may be less than 2.5 kg. The device and/or the box may be approximately 4 kg. The device may comprise the housing.

The device and/or system may comprise a means for moving the at least one objective lens (e.g. into a desired position). The device and/or system may comprise a means for switching between at least two objective lenses. The device and/or system may comprise an objective translation stage (e.g. a slider) for sliding (e.g. laterally) in order to switch between at least two objective lenses. That is, the slider may be configured to slide laterally in order to move between the two objective lenses such that the light transmitted from the sample passes through one of the objective lenses or the other of the objective lenses. The means for moving the at least one objective lens and/or the means for switching between at least two objective slider and/or the slider may be configured to be moved manually (e.g. by a user moving it by hand) and/or controlled and/or automated (e.g. electronically e.g. by a or the processing unit).

The device and/or system may comprise a means to return the at least one objective lens and/or the two objective lenses to a correct and/or a precise position.

The device and/or system may comprise a means to provide automated detection of a position of the objective translation stage and/or an objective mount plate.

The device and/or system may comprise a means to heat, cool or maintain the temperature sample and/or sample slide and/or plurality of channels of a sample slide and/or sample holder and/or sample stage. This may comprise an integrated sample heating and/or cooling system. The device may comprise a heated stage configured to heat and/or maintain the temperature of the sample (and/or a sample slide for holding the sample) at a predetermined temperature. The heated stage may be configured to heat and/or maintain the temperature of a channel or a plurality (e.g. four) of channels of a sample slide at the predetermined temperature. Each or all of the plurality of channels of the sample slide may be maintained at substantially the same predetermined temperature. The predetermined temperature may be either fixed by the device (or system) as an intrinsic value for the device (or system) or selected/tuned by a user through, e.g. use of software. The sample holder may hold the sample slide. The predetermined temperature may be between ambient temperature (e.g. 15 to 25° C.) and 50° C. The sample and/or sample slide may be heated and/or maintained at a desired temperature, e.g. temperature relevant to animal reproduction, e.g. in a range of 36-41° C. (this may be e.g. +/−0.1° C., +/−0.5° C. or +/−1° C.), e.g. substantially 37.5° C. +/−0.5° C. (e.g. for bacteria or spermatozoa), 36° C., 36° C. +/−0.1° C., 36° C. +/−0.5° C., 36° C. +/−1° C., 37° C., 37° C. +/−0.1° C., 37° C. +/−0.5° C., 37° C. +/−1° C., 37.5° C., 37.5° C. +/−0.1° C., 37.5° C. +/−0.5° C., 37.5° C. +/−1° C., 38° C., 38° C. +/−0.1° C., 38° C. +/−0.5° C., 38° C. +/−1° C., 39° C., 39° C. +/−0.1° C., 39° C. +/−0.5° C., 39° C. +/−1° C., 40° C., 40° C. +/−0.1° C., 40° C. +/−0.5° C., 40° C. +/−1° C., 41° C., 41° C. +/−0.1° C., 41° C. +/−0.5° C., and/or 41° C. +/−1° C. The sample may be maintained at other temperatures, depending on the particle, micro-organism or colloid.

The heated stage may comprise a plate that is heated to a predetermined temperature. The heated stage may comprise at least one resistor or a plurality of resistors to heat the plate. The heated stage may comprise two resistors to heat the plate. The heated stage may comprise a temperature sensor to measure the temperature of the plate. The temperature may be continually read through use and the temperature measurement may be accessible in real time. The resistor, the two resistors and/or the temperature sensor may be located in one or more holes in the heated stage. The device and/or system comprises a means for maintaining contact between the heated stage (e.g. the plate) and the sample slide. The sample holder and the heated stage are configured such that the sample slide is in contact with the heated stage (e.g. the plate). This may be by the plate elevating the slide.

The device and/or system may comprise a cooling system and/or cooled stage (e.g. to cool and/or maintain the temperature of the sample at a predetermined temperature). This cooling system or cooled stage may comprise a Peltier module. This may allow more precise control of the temperature over a wider range of temperature.

The device may comprise a heated stage and/or a cooled stage. The heated stage and the cooled stage may be integrated into a heated/cooled stage.

The sample slide may comprise a channel or a plurality of channels for holding a sample or samples. The sample holder may be configured to hold a sample slide with a plurality of channels. The device and/or sample holder may be configured such that a pre-determined position or positions (e.g. for viewing one or more channels of the sample slide) is or are selectable for a plurality of channels of the sample slide. The device and/or sample may comprise the pre-determined position or positions. The sample holder may be configured to slide laterally in order to select a position for viewing one or more channels of the sample slide. This allows simple and easy selection of one of the channels (e.g. four) of the sample slide (e.g. to be viewed).

The device may comprise at least one sensor. The at least one sensor may report measurements of at least one of location, temperature of the heated plate (which corresponds to temperature of the sample) and position of the at least one objective lens. The sensor may report measurements to the processing unit (e.g. software installed in a laptop). Temperature may be displayed on a user interface. The temperature may be live updated every few seconds.

The device may comprise a mechanism to move the sample holder with respect to the at least one objective lens. This may be to bring the sample into focus. The mechanism may comprise a focus knob configured to be rotated to move the sample holder. The device may comprise a means to alert the user when the sample holder has reached the limit of the mechanism (e.g. the base of the mechanism). The means to alert the user may be a micro-switch which is triggered once the sample stage reaches the limit (e.g. the lower limit) and a pop-up window may appear on a screen (more generally a user interface) to let the user know that they should be moving the sample stage in the other direction. The micro-switch may deliver a value of 0 if safe or 1 if approaching the limit. The micro-switch value may be live updated every few seconds—this may be important in focusing the sample. This has the advantage that the user is informed when the limit is reached so that they won't try to keep moving the sample stage down beyond the limit of the mechanism (e.g. if they do not know they are moving it in the wrong direction). If the user kept moving the sample stage down beyond the limit of the mechanism it could break a gear system and render the device inoperable.

The or a processing unit in the device may be configured to at least one of control current to the LED, control current to the heated stage, collect time and/or location of measurement (e.g. by collecting a GPS signal), and/or a signal associated with the alert of the sample stage reaching the limit of the mechanism (i.e. the location sensor) and/or with the position sensor measuring the position of the first objective lens, the second objective lens and/or the objective mount plate. The processing unit may be located on a PCB.

There may be a wireless connection between the processing unit and the cloud where the time correlating intensity fluctuations in the image at each q are analysed to produce parameters describing the particles.

The sample holder, the objective translation stage and/or the mechanism to move the sample holder with respect to the at least one objective lens (e.g. the focus knob) may be accessible from outside the box. The sample holder may be slid laterally such that the location for the sample slide may be accessed externally (e.g. to add, remove or replace the sample slide) or to remove the sample holder completely. The objective translation stage may be slid laterally to switch between objective lenses. The focus knob may be rotated to move the sample holder.

The device may comprise a chassis configured to hold components of the device together. The chassis and/or components of the device may be 3D printed and/or machined. More generally, at least some of the components of the device may be 3D printed.

According to a third aspect of the invention, there is provided a method of measuring at least one parameter of particles in a portable device, the method comprising: providing a sample comprising particles in solution, introducing the sample into a sample holder in the portable device, generating images (e.g. digital images) from an imaging means (e.g. imaging sensor) (e.g. in a camera) in the portable device. In embodiments, the method further comprises recording the digital images at a frame rate of greater than 100 frames per second, preferably, greater than 200 frames per second, more preferably, greater than 300 frames per second.

The method may comprise processing the digital images in a processing unit in the portable device or in a remote processing unit by carrying out Differential Dynamic Microscopy. This may comprise analysing the power spectrum of the difference between pairs of the spatial Fourier transform of the digital images separated by a time delay over a range of time delay and spatial Fourier frequency. This may be over all time delays and spatial frequencies or any subsection. This may be over all possible, or a selection of, pairs of Fourier images and/or over all possible, or a selection of, q values.

The method may comprise selecting the pixel size in the images from a range of 0.1 micron/pixel to 10.0 micron/pixel, preferably 0.5 micron/pixel to 7 micron/pixel.

According to a fourth aspect of the invention, there is provided: a portable device or system according to any other aspect and/or embodiment as described herein, wherein the device is configured such that light from the light source is transmitted to the sample holder without undergoing refraction.

According to a fifth aspect of the invention, there is provided: a portable device or system according to any other aspect and/or embodiment as described herein, wherein the device comprises an objective translation stage for sliding laterally in order to switch between the at least two objective lenses.

According to a sixth aspect of the invention, there is provided: a portable device or system according to any other aspect and/or embodiment as described herein, wherein the device comprises a heated stage and/or cooled stage configured to heat, cool and/or maintain the temperature of the particles in solution, and wherein the sample holder and the heated stage and/or cooled stage are configured such that a slide for holding the particles in solution is in contact with the heated and/or cooled stage in use. The heated stage and the cooled stage may be integrated into a (single) heated/cooled stage.

According to a seventh aspect of the invention, there is provided: a portable device or system according to any other aspect and/or embodiment as described herein, wherein the device comprise at least one sensor for measuring at least one of location, temperature of the heated plate and/or position of the at least one objective lens.

According to an eighth aspect of the invention, there is provided: a portable device or system according to any other aspect and/or embodiment as described herein, and wherein the imaging sensor comprises a pixel size in a range of 0.5 to 10 microns/pixel, more preferably 2 to 5 microns/pixel, and/or the imaging sensor has a frame rate of greater than 50 frames per second, preferably, greater than 100 frames per second, more preferably greater than 300 frames per second.

According to a ninth aspect of the invention, there is provided: a method of manufacturing a portable device for measuring at least one parameter of particles in solution, the method comprising: providing a light source; providing an imaging means (e.g. imaging sensor) for generating images (e.g. digital images); providing an optical system comprising at least one objective lens, and providing a sample holder.

The method may comprise arranging the optical system and imaging sensor such that the pixel size in the image is at least one of a range of 0.1 micron/pixel to 10.0 micron/pixel, preferably 0.5 micron/pixel to 7 micron/pixel.

According to a tenth aspect of the invention, there is provided a computer program comprising computer readable instructions configured to cause a computer to carry out a method in any aspect or embodiment.

According to an eleventh aspect of the invention, there is provided a computer readable medium carrying a computer program as described in the tenth aspect.

According to a twelfth aspect of the invention, there is provided a computer apparatus comprising: a memory storing processor readable instructions; and a processor arranged to read and execute instructions stored in said memory; wherein said processor readable instructions comprise instructions arranged to control the computer to carry out a method in any aspect or embodiment.

Advantages include an easy-to-use, automated and portable instrument for semen analysis. Reproducible motility measurements (errors <5%) may be provided and the method may work for any concentration of semen above 1 million/mL (lower than sex-sorted semen concentrations).

Features in one aspect may be applied as features in any other aspect, in any appropriate combination. For example, apparatus, device and/or system features may be applied as method features and vice versa and in any combination.

It should be understood that the individual features and/or combinations of features defined above in accordance with any aspect of the present invention or below in relation to any specific embodiment of the invention may be utilised, either separately and individually, alone or in combination with any other defined feature, in any other aspect or embodiment of the invention.

Furthermore, the present invention is intended to cover apparatus, device and/or system configured to perform any feature described herein in relation to a method and/or a method of using or producing, using or manufacturing any apparatus, device and/or system feature described herein.

### BRIEF DESCRIPTION OF THE DRAWINGS

Embodiments of the invention will now be described, by way of example only, with reference to the accompanying schematic drawings, in which:

FIG. 1 depicts a perspective view of the device for measuring a parameter of particles in solution according to an embodiment of the present invention;

FIG. 2 depicts a box of the device according to an embodiment of the present invention;

FIG. 3 depicts a longitudinal cross-sectional perspective view of the device according to an embodiment of the present invention;

FIG. 4 depicts a lateral cross-sectional view of the device according to an embodiment of the present invention;

FIG. 5 depicts a longitudinal cross-sectional view of the mirror, lens and camera of the device according to an embodiment of the present invention;

FIG. 6 depicts a differential image correlation function for the delay time tau=0.01 s according to an embodiment of the present invention;

FIG. 7 depicts a differential image correlation function for the delay time tau=0.01 s according to an embodiment of the present invention.

### DETAILED DESCRIPTION

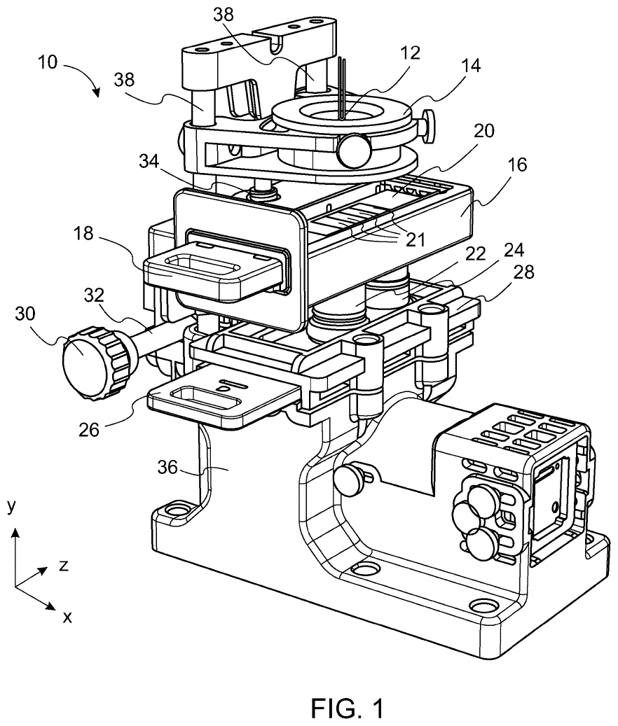

FIG. 1 shows a device 10 for measuring parameters of particles in solution (i.e. a sample). The device 10 may be considered to be a microscope or an imaging module. The device 10 comprises a light source for illuminating the sample, which in this embodiment is a LED 12 in an LED holder 14. In embodiments, the LED 12 may be green. This may be for brightfield imaging and/or phase contrast imaging of the sample. It will be appreciated that, in other embodiments, the LED may be any colour and the light source may be different from an LED.

The particles in the solution may be micro-organisms. The particles in the solution may be colloids, droplets (e.g. milk fat droplets), and/or emulsions. The micro-organisms may be spermatozoa, bacteria such as Escherichia coli known as E-coli, and/or micro-algae. The micro-organisms may range in size from bacteria to micro-algae.

The device 10 may be for measuring a single parameter of the particles or a plurality of parameters of the particles. The parameters of the particles may include motility of the particles, preferably, percentage motility, mean speed, concentration, size, amplitude of head movement, rate of diffusion, and/or frequency of head movement. More generally, fluctuations of the intensity in the images are characterised. The fluctuations in the intensity of the images is due to the particle motion and thus contains all the information of the particle motion. More specifically, the spatio-temporal fluctuations across all images on the video are characterised. In other words: “characterising the spatio-temporal fluctuations of intensity across the images” or “the fluctuations of intensity in space and time across the images”.

The device 10 extends vertically in a y-direction and horizontally in the x-z plane as shown. For ease of understanding, we will refer to the z direction as being lateral and the x direction as being longitudinal. It will be understood that this is just by convention and is not limiting. For example, the device may be entirely in a vertical direction or in a horizontal direction or in two horizontal directions. For example, the z-axis may instead extend vertically, rather than the y-axis as shown in the Figures.

The device 10 includes a sample stage 16 which includes a sample holder 18 which is slidably moveable with respect to the sample stage 16. That is, the sample holder 18 may be slid laterally in the sample stage 16. The sample holder 18 is configured to hold a sample slide 20. The sample holder 18 may be configured to slide laterally in order to select positions for viewing one or more channels 21 of the sample slide 20. For example, the sample slide 20 may comprise four channels 21 and there may be a position for viewing the channels 21 that may be selected for the sample slide 20. This may be without the user viewing the channel directly. There may be a means to provide feedback to a user that the sample slide is correctly in the viewing position (e.g. there may be an audible or tactile click). When the channel is in the correct position below the LED 12, it may be considered to be in a viewing position in a viewing area. The correct position may be directly below the LED or may be an intermediate component between the LED and the sample (e.g. a light diffusor) so it may not be considered directly in this case. It will be appreciated that, in other embodiments, there may be more or less than four channels in the sample slide.

The device 10 is configured such that the light from the LED 12 is transmitted to the sample holder 18 without undergoing refraction. That is, the device 10 does not comprise a condenser lens. The device 10 is configured such that light from the LED 12 is incident on the sample in the sample holder 18 without the light being refracted. In other words, the light is incident directly from the LED 12 onto the sample in the sample holder 18. This has an advantage that the device 10 may be made physically smaller and lighter (i.e. more portable or easier to move). The sample holder 18 may hold a typical microscope sample slide size (75×26 mm and 1 mm thick (imperial) or 75×25 mm (metric) and 1 mm thick) but the sample may be smaller or bigger or thinner or thicker. In other embodiments, the sample holder may be sized to hold different sized samples and/or different sized sample slides.

Standard microscopes include a condenser to focus light into an objective lens. This is because microscopes are intended to use high magnifications which requires more light. A condenser lens is not required in the device 10 as it is generally based on lower magnification and thus does not require high illumination. Avoiding the use of the condenser lens in the device 10 may not adversely affect the imaging and analysis but may allow a reduction of the overall height of the device 10 by approx. 5 cm which may correspond to a 25%-30% reduction in the height (i.e. make it physically smaller).

The device 10 comprises an optical system which includes two objective lenses; a first objective lens 22 and a second objective lens 24. The first objective lens 22 has a lower magnification than the second objective lens 24. The objective lenses 22, 24 are fixedly positioned in an objective mount plate 26 (or objective translation stage), the objective mount plate 26 being located in an objective mount clamp 28. The objective mount plate 26 is slidably moveable with respect to the objective mount clamp 28. The objective mount plate 26 may be referred to as a slider. That is, the objective mount plate 26 may be slid laterally in the objective mount clamp 28 in order to switch between the first and the second objective lenses 22, 24. The objective mount plate 26 may be positioned such that the light reflected from the sample passes through either the first objective lens 22 or the second objective lens 24 (depending on which objective lens is in the correct position). The objective lenses 22, 24, should be positioned correctly for effective imaging (i.e. be aligned with the rest of the optical setup). This means that the objective lenses 22, 24, must return to a precise position. The device 10 may comprise a means to return the objective lenses 22, 24 to the precise position. The means to return the objective lenses 22, 24 to the correct position may comprise a spring ball (not shown) and/or an indent (not shown) in the objective mount plate 26.

In embodiments, the objective mount plate 26 may be moved manually (e.g. by a user moving it by hand) and/or controlled and/or automated (e.g. electronically e.g. by the processing unit). In addition, the means to return the objective lenses 22, 24 to the precise position may manual and/or controlled and/or automated.

There may be provided an automated detection of the position of the objective mount plate 26, i.e. which objective lens 22, 24 is selected for imaging. This may be so that software may automatically detect the selected imaging mode. This may be through a position sensor (not shown) measuring and reporting the position of the first objective lens 22, the second objective lenses 24 and/or the objective mount plate 26.

The device 10 comprises a mechanism to move the sample holder 18 with respect to the objective lenses 22, 24 (actually the sample stage 16 is moved and the sample holder 18 is moved along with it). This may be to bring the sample into focus. The mechanism comprises a focus knob 30 configured to be rotated to move the sample holder 18. The knob 30 is attached to a rod 32 which, through a gearing system (not shown), rotates a lead screw 34 which moves a lead screw nut (not shown) up and down. The lead screw nut is attached to the sample stage 16 which means the sample stage 16 moves up and down as well. The total travel distance that the sample stage 16 may move may set the focal depth range for DDM processing and visual imaging.

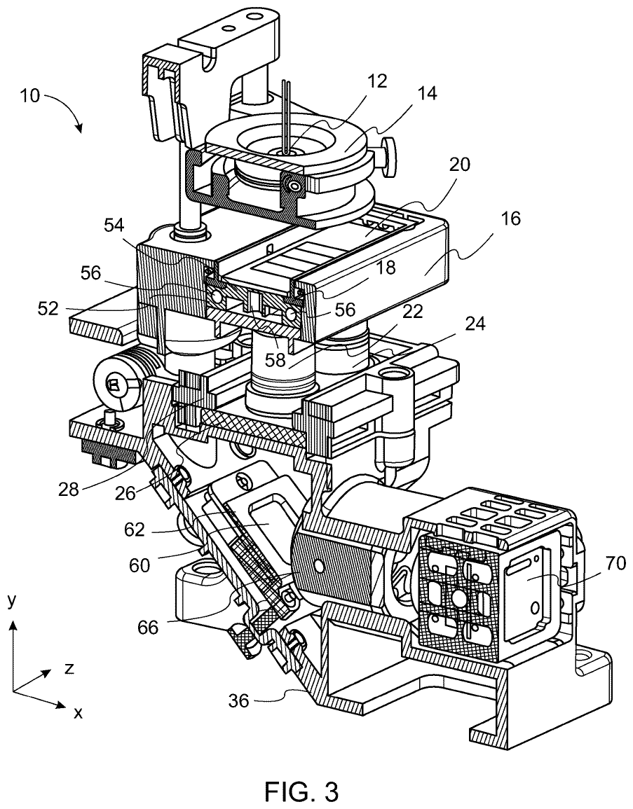

The device 10 may comprise a means to alert the user when the sample holder 18 (actually sample stage 16) has reached the limit of the mechanism (e.g. the base of the mechanism). The means to alert the user may be a micro-switch (more generally a location sensor) which is triggered once the sample stage 16 reaches the limit (e.g. the lower limit) and a pop-up window may appear on a screen (for example) to let the user know that they should be moving the sample stage 16 in the other direction. This has the advantage that the user is informed when the limit is reached so that they won't try to keep moving the sample stage down beyond the limit of the mechanism (e.g. if they do not know they are moving it in the wrong direction). If the user kept moving the sample stage down beyond the limit of the mechanism a gear system may break and potentially render the device 10 inoperable. This may be used to avoid contact between the heated stage 52 (see FIG. 3) and one of the objective lenses 22, 24, (e.g. the objective lens not in use during imaging).

The sensors may report the measurements to a processing unit. The measurements may be provided to a user (e.g. via a screen).

A base enclosure 36 is located at the bottom of the device 10 and surrounds other components of the device 10, which will be described later. The base enclosure 36 may be for ensuring a relatively closed environment e.g. so that dust does not build up on the optical system or eternal light does not affect the imaging. Two guide rods 38 may extend vertically substantially the full height of the device 10 and hold components of the device 10 together. However, in other embodiments, other ways may be used to allow y-axis movements. The base enclosure 36 and/or the two guide rods 38 may form part of a chassis of the device 10. The chassis may include other parts of the device 10 not specifically mentioned which may hold components of the device together. The chassis and/or other components of the device 10 may be 3D printed and/or machined. For example, all the components of the microscope except for rotating elements of the y-axis sub-system, the y-axis guide rods and the heated stage may be 3D printed. A substantial part or at least half of the mass of the device 10 may be in the bottom quarter of the device 10. This has an advantage of helping to prevent it from tipping over.

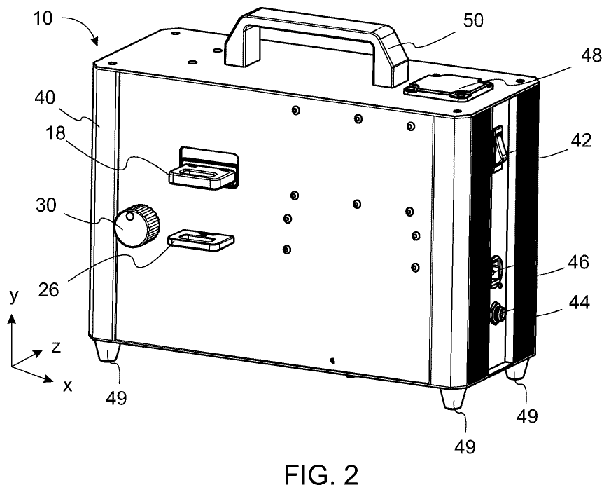

FIG. 2 shows the device 10 enclosed in a box 40. The box 40 may be considered to form part of the device 10 and the box 40 may be considered to substantially fully enclose the components of the device 10 (except as will be described). As can be seen, part of the sample holder 18, part of the objective mount plate 26 and the focus knob 30 are visible and accessible outside the box 40. The sample holder 18 and the objective mount plate 26 pass through slots in the box 40. The knob 30 may be rotated from outside the box 40 to move the sample holder 18 up and down. As can be seen, the slot in the box 40 around the sample holder 18 extends in the vertical (y) direction such that the sample holder 18 may move up and down. In addition, the sample holder 18 may be slid laterally away from the box 40 such that the location for the sample slide 20 may be accessed externally (e.g. to add, remove or replace the sample slide 20) or to remove the sample holder 18 completely. In addition, the objective mount plate 26 may be slid laterally away from the box 40 in order to switch from the first objective lens 22 to the second objective lens 24. Likewise, the objective mount plate 26 may be slid laterally towards the box 40 in order to switch from the second objective lens 24 to the first objective lens 22. Thus, the switching between the first and second objective lenses 22, 24 may be carried out externally to the box 40.

In embodiments, some of the components of the device 10 may be motorised and/or there may be an automated system. For example, these components may include the sample stage 16, the sample holder 18 and/or the objective mount plate 26. This may mean that the part of the sample holder 18 and/or the part of the objective mount plate 26 external to the box 40 that may be gripped by the user and/or the focus knob 30 may not be required. In this case, there may be no requirement for the user to select the sample holder 18, the objective mount plate 26 and/or the focus knob 30 outside the box 40 (other than to insert the sample slide 20 into the box 40). This may mean that the box 40 may be more enclosed and protected from the environment.

The box 40 may be water and/or dust resistant and/or be made from a relatively durable material (e.g. aluminium, various commodity plastics (PP, glass fill, HDPE, ABS, PC/ABS blends, TPE overmouldings). Advantages of enclosing the components of the device 10 in the box 40 include the following: The components may be kept dry (protecting condensation on the optical components), clean, protected from light and dust etc, protected from physical damage, and may not be contaminated by the environment (e.g. on location at a farm). In addition, users cannot access the components to modify settings etc which may result in inaccurate results. The box 40 also adds user interface points for moving, storing, operating, transporting the device 10. The box 40 may also provide EMC shielding. Furthermore, more components (such as electronic components) may be added into the box which may help provide a safe environment to the user and/or improve EMC shielding. The device 10 and/or the box 40 may comprise a vibration or shock absorber. Vibrations may be detrimental for microscopy imaging and having a vibration or shock absorber may alleviate this.

The box 40 includes an on/off switch 42. In this embodiment, the device 10 is mains powered and the box 40 includes a connection 44 for mains power supply. In other embodiments, the device 10 may be battery powered (battery not shown). In some embodiments, the device 10 may have the option of both mains and battery power.

The box 40 also includes a USB connection 46 for transferring data from the device 10 (i.e. external to the box 40). This may include data from the imaging sensor and/or the camera. This may also include from any other components that may provide data, for example the GPS signal and/or an electronic board that gather temperature readings from the sample stage 16 to the software for a real-time reading of the sample temperature. It will be appreciated that this is just an example, and other means for transferring data from the device 10 (outside the box) may be used. In other embodiments, there may be no USB connection and the data may be transferred wirelessly or processing of the data may be carried out in the box 40. In embodiments, the device 10 may be operated through a Windows 10 laptop.

The box 40 also includes a GPS locator cap 48, under which is a GPS antenna (not shown). The cap 48 may be 3D printed. The GPS antenna may not be enclosed in the box 40 (which may be metallic) as otherwise there may be no signal (or at least a reduced signal). Also provided is a PCBA to gather the signal from the GPS antenna. It will be appreciated that, in other embodiments, there may be other ways to detect the location of the box 40 (and where the measurement may take place).

The device 10 is portable. For example, it may be moved by hand by a person and it is relatively small and light weight. The device 10 (including the box 40) may have dimensions of approximately 30×20×15 cm, and, more generally, may be less than 40×30×20 cm. The device 10 (including the box 40) may be less than 5 kg, more preferably, the box may be 2.5 kg. For example, the box 40 may be approximately 4 kg. The box 40 may comprise a handle 50 for ease of carrying. The device 10 does not need to be used in a laboratory environment (even though it can be) and does not need to be dismantled into component parts to be moved.

The box 40 also includes four feet 49 (only 3 shown). These feet 49 may be anti-vibrational feet which may help provide good video imaging. It will be appreciated that in other embodiments, there may be more of less than four feet. More generally, in embodiments, the box may include feet, more preferably anti-vibrational feet.

FIG. 3 is a perspective cross-sectional view taken longitudinally through the device 10 (i.e. along the x direction). The components of the device 10 which were hidden behind the base enclosure 36 in FIG. 1 are now shown.

A cross-section through the sample stage 16 is shown. The device 10 also includes a heated stage 52. The heated stage 52 is configured to heat and/or maintain the temperature of the sample at a predetermined temperature by heating and/or maintaining the temperature of the sample slide 20 which holds the sample. The predetermined temperature may be between ambient temperature (e.g. 15 to 25° C.) and 50° C. There may be a maximum temperature set that depends on the material surrounding the heated stage 52 (e.g. based on the max temp for the 3D printed material). The sample and/or sample slide 20 may be heated and/or maintained at substantially 37.5° C. +/−0.5° C. (e.g. for bacteria or spermatozoa). The sample may be maintained at other temperatures, depending on the micro-organism or colloid. In embodiments, alternatively or additionally, the device 10 may comprise a cooling system (e.g. to cool and/or maintain the temperature of the sample at a predetermined temperature). This may include a Peltier module. This may allow more precise control of the temperature over a wider range of temperature.

The heated stage 52 comprises a plate 54 (e.g. made of aluminium) that is heated to the predetermined temperature. The heated stage 52 may comprise resistors (not shown) located in two side holes 56 to heat the plate 54. There may be two resistors. There may be six resistors in series, three resistors in each side hole. This may provide relatively good homogeneity of the temperature through the plate. There may be a different number of resistors to two or six. The heated stage 52 may comprise a temperature sensor (not shown) to measure the temperature of the plate 54. The temperature sensor may be located in a central hole 58 in the heated stage 52. The temperature may be continually read through use and the temperature measurement may be accessible in real time. The measurement may be made e.g. every second.

The sample holder 18 and the heated stage 52 are configured such that the sample slide 20 is in contact with the heated stage 52 (i.e. the plate 54). This may be by the plate 54 elevating the sample slide 20. This may because an upper surface of the plate 54 is above the surface of the sample holder 18 that the sample slide 20 sits on. In other words, the sides of the (3D printed) sample holder 18 may be lower than the upper surface of the plate 54 so that when the sample slide 20 is slid in, it only touches the heated plate 54. There may be no sprung or active force pushing the sample slide 20 into the heated plate 54. They may just be in nominal contact and rely on gravity to maintain the contact. There may be a vertical restraint on the sample slide 20 with a sample holder 18 lock and a lip on the sample holder 18. However these features are more to aid in manual manipulation of the sample prior to going into the device 10, rather than maintaining contact with the heater plate.

The device 10 also comprises a mirror 60 held within a mirror mount 62. The mirror 60 may be considered to form part of the optical system of the device 10.

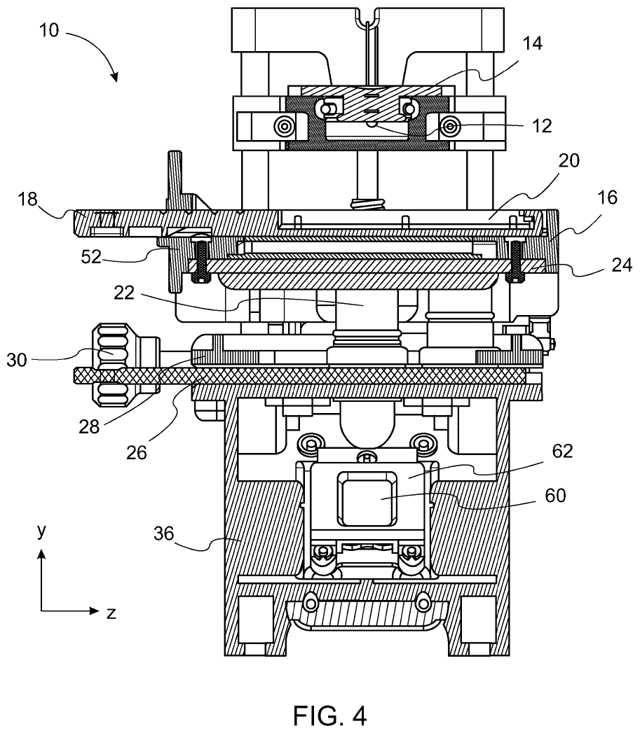

FIG. 4 shows a cross-sectional view taken laterally through the device 10 (i.e. along the z direction) and shows the LED 12, the first objective lens 22 and the mirror 60 aligned with each other. This means that the light from the LED 12 will be incident on the sample in the sample slide 20 (the sample being the one that is in the channel 21 of the sample slide 20 which is positioned in the viewing area). The light is then transmitted through the sample and incident onto the first objective lens 22, which transmits the light onto the mirror 60, with the light then being reflected from the mirror 60. The mirror 60 reflects the light approximately 90 degrees (i.e. from vertical to horizontal—out of the page as shown). The use of the mirror 60 means that the height of the device 10 may be reduced. The mirror 60 may be provided in order to fit the components of the device 10 into a stable and conveniently sized box 40. It will be appreciated that, in other embodiments, the mirror 60 may not be required.

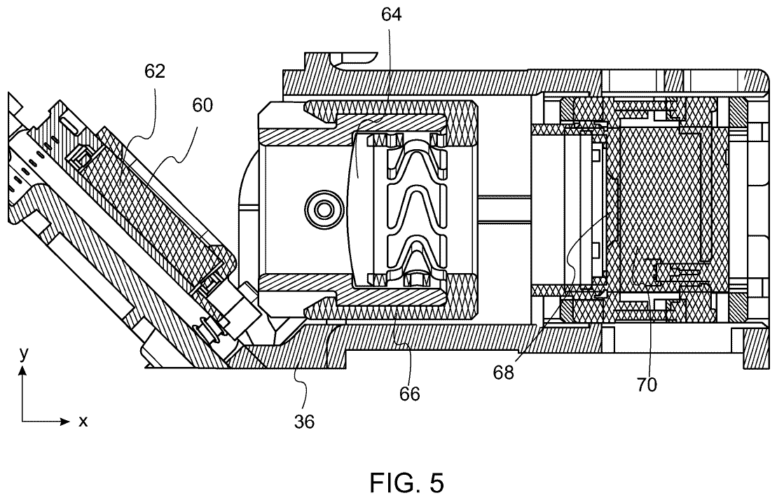

Turning again to FIG. 3, the light reflected from the mirror 60 is incident on a lens 64 (not shown in FIG. 3 but see FIG. 5) in a lens holder 66. The lens 64 may be considered to form part of the optical system of the device 10 and may be termed a further lens. The lens 64 focuses the light onto an imaging sensor 68 (see FIG. 5) in a camera 70. The lens may allow parfocal imaging, i.e. which allows same focal plane (approximately) when changing the objective and/or fine tuning the size of a pixel in the resulting image by moving the lens in the horizontal plane—thus the lens may be referred to as a tuning lens. The imaging sensor 68 is for generating digital images. The camera 40 may be digital camera (including an imaging sensor 68) which is embedded in a camera mount, which may be made of 3D printed material. Material surrounding the camera mount may allow for ventilation to avoid over heating of the camera 70. The position of the camera 40 (and thus the imaging sensor 68) may also be adjustable or adjusted in the x plane to fine tune the size of a pixel in the resulting digital image.

FIG. 5 shows a cross-sectional view taken longitudinally through part of the device 10 (i.e. along the x direction). In FIG. 5, the mirror mount 62, the mirror 60, the lens 64, the lens holder 66, the camera 70 and the base enclosure 36 are all shown. The lens 64 may be a plano convex lens.

The sensors may report the measurements to a processing unit. The measurements may be provided to a user (e.g. via a screen).

The device 10 may comprise a processing unit (not shown) in the box 40 for processing the digital images and obtaining the parameters of the particles in the solution. In other embodiments, there may be a system comprising the device 10 and a remote processing unit for processing the digital images and obtaining the parameters of the particles in the solution. In embodiments, the processing unit and/or the remote processing unit may comprise a 1) laptop computer (e.g. using Windows 10), 2) desktop computer, 3) embedded processing within the unit, 4) tables or smart-phone, 5) cloud, 6) mix of one or more of 1) to 5). There may be a wired or wireless connection between the device 10 and the processing unit and/or the remote processing unit.

The parameters of the particles in the solution (i.e. the sample) may be obtained by the processing unit (either in the box 40 or remote from the box 40) analysing (or calculating) the power spectrum of the difference between pairs of the spatial Fourier transform of the digital images separated by a time delay over a range of time delay and spatial Fourier frequency. This may be done by digitally processing the images through a Fourier Transform of each image so that a wavevector q represents the spatial domain and time correlating intensity fluctuations in the image at each q. This may be referred to as differential dynamic microscopy (DDM).

The analysing the power spectrum of the difference between pairs of the spatial Fourier transform of the digital images separated by a time delay over a range of time delay and spatial Fourier frequency may comprise: (1) calculating the differential image correlation function (DICF), i.e. calculating the spatial Fourier transform of the images and then calculating the power spectrum of the difference of pairs of the Fourier images over a range of accessible delay time tau (i.e. time difference between two selected images) and spatial frequency (q) provided by the Fourier transform of the images. All possible pairs of Fourier images or a selection of pairs of Fourier images may be considered. The calculation may be carried out over all possible, or a subsection of, pairs of the Fourier images. (2) then averaging all resulting DICF which has the same delay time (tau) together, (3) then performing a radial average for each q values yielding the final time-averaged and vector{q}-averaged DICF as a function of delay time tau and spatial frequency q. All possible q values or a selection of q values may be considered. The calculation may be carried out over all possible, or a subsection of, q values. DDM involves calculating the power spectrum of the difference of pair of images. This process involves the calculation of a Fourier transform which defines the Fourier component q which defines a length-scale. The spacing between the pairs of images define the delay time tau. In practice, the range of q values is defined by the image size in pixel and the size of a pixel in the image. Standard practice calculates the Fourier transform for all possible q values, which may correspond to half of the number of pixels of an image. The total number of pairs of Fourier images may be calculated by N*(N−1)/2, with N being the number of images. Thus considering all possible pairs and all possible q values requires significant computer power and memory to store all the calculations in memory. Taking a sub selection (a subsection) of the number of pairs of Fourier images (e.g. only considering a tenth of the pairs of images) and q values (e.g. ˜20 values of q compared to the 256 q values expected for images with 512×512 pixel size) means that the processing time can be reduced. For example, processing time may be reduced from ˜10 min (e.g. using a laptop with 16 Gb RAM) to ˜2 min, and the memory usage may be reduced from ˜12 GB to ˜5 Gb for a video of 10000 images with image size of 512×512 pixels. Importantly, this allows the use of a lower spec processing unit, e.g. a laptop with 8 Gb RAM rather than a 16 Gb laptop. In embodiments the subsection (or sub-selection) of the pairs of Fourier images and/or q values may be calculated using an algorithm or may be selected by a user or may be determined in another way. The minimum number of possible pairs of Fourier images per delay time used in the size of the subsection may be 10. This may give a result that is within e.g. 10% of the true result. The minimum number of pairs of Fourier images per delay time may depend on the concentration of particles and the size of the particles.

Processing of the digital images and imaging techniques may be carried out by Differential Dynamic Microscopy (DDM). Processing of the digital images and imaging techniques may be carried out by using any feature or any method as described in (High-throughput characterisation of bull semen motility using differential dynamic microscopy (plos.org) (PLoS ONE 14(4): e0202720. https://doi.org/10.1371/journal.pone.0202720) and Differential Dynamic Microscopy: A High-Throughput Method for Characterizing the Motility of Microorganisms (Biophysical Journal Volume 13 Oct. 2012 1637-1647), which are both herein incorporated by reference.

There may be a wireless connection between the processing unit (wherever it is) and the cloud where the temporal correlating Fourier image intensity fluctuations at each q are analysed to produce parameters describing the particles.

The processing unit may be configured to control current to the LED 12, control current to the heated stage 52, collect time and/or location of measurement (e.g. by collecting a GPS signal), and/or a signal associated with the alert of the sample stage 16 reaching the limit of the mechanism (i.e. the location sensor) and/or with the position sensor measuring the position of the first objective lens 22, the second objective lens 24 and/or the objective mount plate 26. The GPS signal may be to provide accurate timestamps so that continuous measurements of motility parameters may be performed over time. The location of measurement (of parameters of the particles) may also be determined using the GPS signal so that it may be determined where the sample (e.g. semen) was tested and explore correlations in the measurements with other factors, e.g. weather, diet, environmental conditions etc. The processing unit may be located on a PCB.

The device 10 or the system may comprise a means for displaying the parameters of particles in solution. The means for displaying the parameters of particles in solution may be a screen (not shown).

As mentioned above, the two objective lenses 22, 24 each have different magnifications. The first objective lens 22 is for allowing images to be captured for DDM processing (e.g. to measure the micro-organism motility). The second objective lens 24 is for visual inspection of the particles (e.g. to visualise particles in solution at a resolution at which a head of the micro-organism is in a range of 5 to 15 pixels in size in the image). It will be appreciated that, in other embodiments, the first objective lens may be for visual inspection and the second objective lens may be for DDM processing. In other embodiments, there may a single objective lens that may be for e.g. only DDM processing. In embodiments, both the first and/or second objective lenses may be used for further image processing other than DDM.

In embodiments, both the first and the second objective lenses 22, 24 may be used for DDM processing, albeit for different sized particles in solution. For example, the first objective lens 22 may be used for DDM of spermatozoa and the second objective lens 24 may be used for visual inspection of spermatozoa and DDM for differently sized particles (such as bacteria and algae). Thus, the objective lenses may be for more than one purpose.

The first and/or second objective lenses 22, 24 (e.g. specifically for spermatozoa) may have a sufficiently big depth of field so that the resulting digital image contains all cells across the vertical cross section of the channel, e.g. 20 micron height channel. This may remove the need to collect images at different focal plane through the sample.

The first and/or second objective lenses 22, 24 may provide a relatively large field of view so that a large volume of the sample is imaged. This may remove the need to collect images over different locations of the sample for better statistics.

The optical system and the imaging sensor 68 are configured such that the pixel size in the image may be selected for different particle sizes. That is, the magnification of the first and/or second objective lenses 22, 24, the distance between the objective lenses 22, 24 and the imaging sensor 68, and the size of pixels in the imaging sensor 68 are each chosen such that the pixel size in the image (i.e. the resolution) is predetermined or falls within a predetermined range. Thus, the device 10 may be preconfigured to provide the desired pixel size in the image.

As an example, the first objective lens 22 may have a magnification such that a head of a micro-organism (e.g. spermatozoa) is in a range of 1 to 5 pixels in size in the image.

As other examples, the first objective lens 22 and/or second objective lens 24 may have a magnification in a range of 1× to 4× (e.g. for spermatozoa), in a range of 5× to 10× (e.g. for bacteria such as E-coli), and/or in a range of 5× to 20× (e.g. for micro-algae).

The pixel size in the image may be substantially 0.9, 1.7, 2.1 and/or 4.3 micron/pixel. For example, 0.9, or more specifically 0.86, micron/pixel allows imaging of flagellum (e.g. approx. 1 micron thick) of spermatozoa and/or micro-algae. 4.3 micron/pixel allows DDM to be carried out for spermatozoa and/or micro-algae. 0.9, 1.7 and/or 2.1 micron/pixel allows DDM to be carried out for bacteria.

The imaging sensor 68 may have a pixel size in a range of 0.5 to 10 microns/pixel, more preferably 2 to 5 microns/pixel.

The imaging sensor 68 may be configured to be run in 1×1, 2×2 and 4×4 binning mode. The imaging sensor 68 may be configured to be run in skipping mode.

Once the components of the device 10 are enclosed in the box 40, the user may only switch between objective lenses 22, 24 to switch between different modes (e.g. visual and DDM processing) and they may not change the settings in another way to modify the pixel size in the image.

The imaging sensor 68 may have a frame rate of greater than 50 frames per second, preferably, greater than 100 frames per second, more preferably greater than 300 frames per second. The higher frame rate may allow faster particles to be characterised, e.g. small particle with size smaller than 100 nanometers in diameter, or fast swimmers, e.g. speed above 50 microns.

In use, a user adds a sample comprising particles in solution onto a channel 21 of the sample slide 20 and then puts the sample slide 20 into the sample holder 18 (which has been slid away from the box 40 for access). The sample holder 18 is then slid into the box 40 until a click is heard by the user which tells the user that the channel is in the correct position to be viewed.

The first and/or second objective lenses 22, 24 are selected based on the desired imaging. That is, the pixel size in the images (micron/pixel) is set based on the purpose. For example, the objective mount plate 26 may be slid laterally towards the box 40 such that the first objective lens 22 is in the viewing position if it is desired to carry out DDM on spermatozoa.

The light from the LED 12 illuminates the sample, the light from the sample is then transmitted by the first objective lens 22, reflected from the mirror 60, refracted (e.g. focused) by the lens 64 and then is incident on the imaging sensor 68. The sample stage 16 is then moved up and/or down to bring the sample into focus. The user may see a screen with a livestream of the imaging and then adjust the focus knob 30 accordingly.

The imaging sensor 68 generates digital images which are then processed by the processing unit. The processing unit analyses (or calculates) the power spectrum of the difference between pairs of the spatial Fourier transform of the digital images separated by a time delay over a range of time delay and spatial Fourier frequency in order to obtain the parameter of particles in solution (e.g. motility of sperm). The results may be presented to the user on a screen.

The data collection and/or data analysis may be automated to produce the measurement of the parameter of the particles. In embodiments, the device and/or system may include a means for user interaction (such as button) to perform the data collection and/or data analysis. The data collection and/or data analysis may be automatically carried out by the user clicking the button (e.g. a single time). The measurements or sequence of measurements may be carried out (in real time) over time (e.g. for up to 12 hours) by the user simply clicking the button (i.e. a single user interaction).

In embodiments, the pixel size in the image may be in a range of approximately 2 to 7 micron/pixel. This may be considered to be an optimal range as explained below. For clarity, all pixels in the image may have the same size but the size of the pixels in an image may be tuned through optics, imaging sensor, etc. For DDM to work for e.g. semen motility, low magnification may be needed to be carried out in order to reach required low q values. Low q values may be considered to be <0.4 μm⁻¹, or in a range of 0.05 μm⁻¹ to 0.4 μm⁻¹. Low magnification may be considered to mean that the pixel size in the image is between approximately 2 micron/pixel and 7 micron/pixel. To illustrate why the range of 2 micron/pixel to 7 micron/pixel may be considered to be an optimal range (e.g. for semen motility), three examples (a), (b) and (c) of the pixel size in the image, and the consequences of these sizes, are provided below. Example (a) is at the lowest extreme of the range of 2 to 7 micron/pixel, Example (c) is at the highest extreme of the range of 2 to 7 micron/pixel, and Example (b) is in approximately the middle of the range of 2 to 7 micron/pixel.

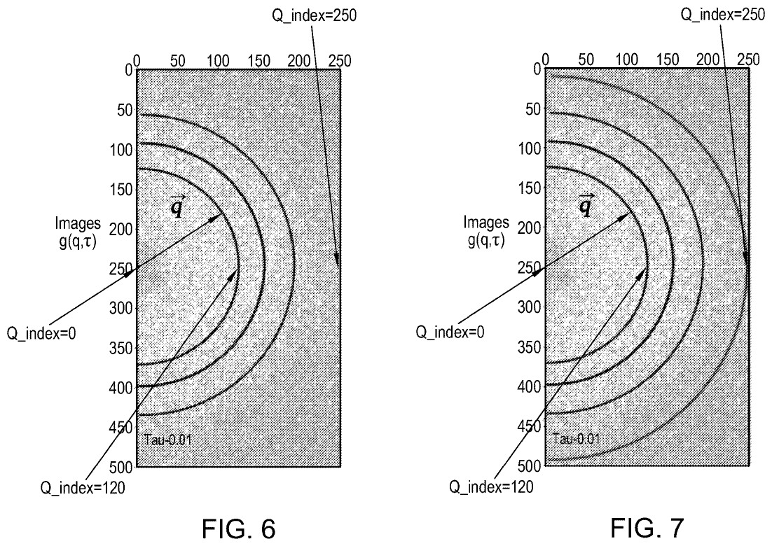

An important aspect is that DDM applied to e.g. semen motility measurements may require q values in the range approximately 0.05 μm⁻¹ to 0.4 μm⁻¹, the final range depending on species of animal. The accessible q values depend on both the pixel size in the image (i.e. image pixel size) and size of the image(s) in pixels (image size in pixel). Q value is the true value of the spatial Fourier frequency q and has a dimension of the inverse of a length (e.g. here 1/micron). Q index is the number of pixels along the radial line of the Fourier images at which the radial averaging is performed. An example is provided to illustrate what is meant by q index using FIG. 6. When calculating the differential image correlation functions (DICFs), there is one image per DICF at a given delay time. FIG. 6 shows the DICF for the delay time tau=0.01 s. This resulting image is 251 pixels wide and 500 pixels high. The radial average is then performed, which means averaging all the values of this image along a semi-circle donated as the black line. The radius of this line can be defined as the number of pixel along the radial line from the centre of the image. Thus, q_index=0 means the very first pixel in the centre of the image. Q_index=250 is the very last pixel on the right hand side. The true value of q depends on the radius used to calculate the radial average and thus requires knowledge of the pixel size, where the radial average is performed (which is defined by q_index) and the total size of the image in pixel. The equation to calculate the q value from the q index is the following:

Equation 1: Q=2*pi*qindex/(image pixel size*image size in pixel). For example, for an image with pixel size=4.3 um, image size in pixel=512 pixels, and q index=80→q=0.228 μm⁻¹.

Low q indices have less pixel to perform the radial average to obtain the final differential image correlation function (DICF) and thus bring noisier DICFs, which may make successful measurements of semen motility more difficult. Low q indices will have a smaller radius hence the radial average will be performed over a lower number of pixels. An example is provided to illustrate what is meant by low q indices using FIG. 7. Low q indices means that the radius of the semi-circle will be smaller and thus its circumference will be smaller and thus there will be less pixels. A simple example: Considering the very first q_index (which is called q_index=0 in FIG. 7); at such q_index there is only one pixel (which is at the mid-centre and left side of the image). Considering the very last q_index (which is called q_index=250 in FIG. 7); the radius of the largest semi-circle will be the biggest possible in this image and will have many pixels. In embodiments, a lower limit of q index may be 20 (this may be good practice) or it may be OK to use 10.

The examples below have been restricted to no more than 512×512 pixels in the images. This is related to reducing computer RAM and processing time required to process the images. That is, processing bigger images requires more computer RAM and more processing time. For example, to process 10,000 images at 512×512, using a standard DDM algorithm may require a minimum of 12 Gb free of RAM, with the time to process depending on the exact algorithm used. Using 1024×1024 pixels in the image instead of 512×512 pixels may require 12 Gb×4=48 Gb of free RAM. Using 512×512 pixels means that the total q indices available are then from 0 to 255. In practice an increment of q_index may be taken to be one pixel in the fourier image. However, any increment with sub-pixel level may be taken in the fourier image. Thus, as an example here, the increment is one pixel in the fourier image. In embodiments, all possible q values may be taken for processing (and be processed). All the possible q values may correspond to half of the number of pixels in an image. However, in other embodiments, a subsection of all possible q values may be taken. For example, for a video with 512×512 pixels, instead of taking all the q indices from 0 to 255, only a range of the q indices from 0 to 255 by a predetermined step may be kept for the Fourier images. That is, a subsection of the entire range of q indices is selected and, within that subsection, only every x (predetermined step) of the q indices may be kept. Using a subsection (or sub-selection) of all of the q indices means that the amount of RAM used may be reduced (e.g. by a relatively very large amount when compared to processing all of the q indices). This allows the use of a low (or lower) specification processing unit (e.g. laptop) and faster processing so that results may be obtained in a shorter time (e.g. half the time or shorter). It will be appreciated that the absolute length of time depends on computational power. The specific range of subsection of q indices will depend on the image sizes, e.g. it may be a different range (and may be a different predetermined step) for 328×328 images. It will be appreciated that there are many possible different ranges of subsection and steps that may be used that may provide satisfactory results (e.g. obtain the parameter (such as amplitude of head movement) to the desired level of accuracy). The minimum number of possible q values considered in the size of the subsection may be 1.

Example (a): Pixel size in the image=2 micron/pixel. This may be by using the first objective lens 22 to capture images for DDM processing (e.g. to measure semen motility). That is, using a magnification that may be considered to be low (with respect to standard microscopy). In other words, the set up is for DDM imaging and may be referred to as DDM imaging mode.

i. total field of view for 512×512 is ˜1 mm×1 mm. More precisely, (2*512)\hat{ }2=(1.024)\hat{ }2 mm\hat{ }, using, field of view=(image pixel size*image size in pixel).

ii. Using Equation 1, the q indices required to get q=0.05 to 0.4 μm⁻¹ are q indices=8 to 65. For example, using q index 65, then q=2*pi*65/(2*512)=0.399 μm⁻¹ ˜0.4 μm⁻¹. Needing to use q indices of 8 to 65 means that the lower end of q indices needs to be accessed, which is not ideal as they may result in increased noise in the DICF.

iii. Using the set up for visual imaging (may be referred to as visual imaging mode): This may be by using the second objective lens 24 to capture images for visual inspection (e.g. of spermatozoa). This may be based on 10× magnification which may give an image pixel size of 0.4 micron which is good to see individual flagellum of spermatozoa.

Example (b): Pixel size in the image=4.3 micron/pixel, using DDM imaging mode.

i. Total field of view is ˜2.2 mm×2.2 mm. More precisely, (4.3*512)\hat{ }2=(2.2016)\hat{ }2 mm\hat{ }2. This means that there are 4.62 times more cells in the field of view (when compared to Example (a), as the field of view is about 4.62 times bigger, [(2.2016/1.024)\hat{ }2=4.62]) and thus an average may be taken over a higher number of cells. At a given concentration, there will be 4.62 times more cells than for Example (a).

ii. Using Equation 1, the q indices required to get q=0.05 to 0.4 μm⁻¹ are q indices=18 to 140.

iii. Additionally, the image size may be reduced from 512×512 to 238×238 which would give the same final field of view as Example (a) as the pixel size in the image is bigger. That is, (4.3*238)\hat{ }2=(1.024)\hat{ }2 mm\hat{ }2, which is the same as Example (a). This may allow ˜4× less of required free RAM and much faster DDM processing. In such case, the q indices to be considered would be the same as in Example (a) [see point ii].

iv. Therefore there is an advantage of using 4.3 micron/pixel for the pixel size in the image in terms of an improvement in the selection of the q indices and overall size of the images for optimised DDM processing.

v. The visual imaging mode (based on 10× magnification) may give an image pixel size of 0.86 micron, which is not as good as in Example a (see point iii) but is enough to see individual flagellum.

Example (c) Pixel size in the image=7 micron/pixel, using DDM imaging mode.

i. Total field of view is ˜3.6 mm×3.6 mm. More precisely, (7*512)\hat{ }2=3.584\hat{ }2 mm\hat{ }2. Thus, the total field of view is 2.65 [(3.584\hat{ }2)/(2.2016\hat{ }2)=2.65] times bigger than the optimal case in Example (b) [see point i].

ii. Using Equation 1, q indices required to get q=0.05 to 0.4 μm⁻¹ are q indices=28 to 228, which is in the ideal range of q indices as it is above 20, although this is a rough estimation.

iii. However, it is challenging to maintain all cells in the focal plane over such a large field of view due to inherent optical aberrations, which may ultimately not be necessary.

iv. To give a similar field of view as the optimised case in Example (b), the image size may be reduced to 316×316, which will reduce the amount of free RAM required and would also speed up the DDM processing.

v. However, the visual imaging mode (based on 10× magnification) may give an image pixel size of 1.4 micron, which won't be as good for viewing individual flagellum as in Example (b) [see point v], but could still be applicable.

All three Examples (a), (b) and (c) should work for DDM processing using the DDM imaging mode and observing the flagellum of the spermatozoa using the visual imaging mode although there are pros and cons for each example. For the visual imaging mode, it may be considered to use a higher magnification (say a 20× magnification instead of 10× magnification), but this brings other physical issues such as, for example, a shorter working distance from the top of the objective lens to the where it is desired to focus in the sample. An extra-large working distance of 20× magnification exists, but are more expensive in general.

It will be appreciated that, although a pixel size in the image of 4.3 micron/pixel is mentioned (and may be considered to be particularly advantageous), there may be other values (e.g. around 4.3 micron/pixel) that may be used and that have the same or similar advantages (even if they are to a lesser extent). For example, in some embodiments, the pixel size in the image may be in a range of 4 to 4.5 micron/pixel.

As mentioned previously, there are numerous factors that may contribute to and affect a desired pixel size in the image. For example, the pixel size in the imaging sensor, the optical system set up (e.g. the optical components such as the objective lens or other lens, and the positions between the optical components in the optical system), and how the imaging sensor (or more particularly the camera including the imaging sensor) is operated, e.g. the binning mode used or set.

As an example, the pixel size in the imaging sensor may be 4.8 micron. This may correspond to Example (b). DDM imaging mode: Pixel size in the image=4.3 micron/pixel (using 4× magnification (of the objective lens)+2×2 binning). Visual imaging mode: Pixel size in the image=0.86 micron/pixel (10× magnification+1×1 binning). Although 4.8 micron is used here for the pixel size in the imaging sensor, other values may be used. However, this may require tuning the optical setup by using a lens with a different optical property between the objective and the camera (imaging sensor) or changing the distance of the camera from the objective. Another example may be to use a camera with imaging sensor pixel size of twice smaller but recording in 4×4 binning (twice bigger than when using 2×2 binning). However, to reach the final size of 512×512 for example, this would require a camera which has an imaging sensor of 4× larger: 2048×2048 and ensuring that the high frame rate is still possible.

Using the pixel size in the imaging sensor of 2 micron may correspond to Example (a). DDM imaging mode: Pixel size in the image=(or ˜) 2 micron/pixel (using 4× magnification+2×2 binning). More precisely, 1.8 micron/pixel; calculated from scaling: with 4.8 micron pixel in imaging sensor, 4.3 micron in image is obtained, thus using 2 micron pixel size in the sensor gives 4.3*2/4.8=1.8. Visual imaging mode: Pixel size in the image=(or ˜) 0.4 micron/pixel (using 10× magnification+1×1 binning).

Using the pixel size in the imaging sensor of 8 micron may correspond to Example (c). DDM imaging mode: Pixel size in the image=(or ˜) 7 micron/pixel (using 4× magnification+2×2 binning). More precisely, 7.2 micron/pixel; calculated from scaling: with 4.8 micron pixel in imaging sensor, 4.3 micron in image is obtained, thus using 8 micron pixel size in the sensor gives 4.3*7/4.8/8=7.2. Visual imaging mode: Pixel size in the image=(or ˜) 1.4 micron/pixel (using 10× magnification+1×1 binning).

It will be appreciated that, although the pixel size in the imaging sensor of 4.8 micron is mentioned, in other embodiments, there may be other values (e.g. around 4.8 micron/pixel) that may be used. For example, in some embodiments, the pixel size in the imaging sensor may be in a range of 4 to 5 micron/pixel.

It will be appreciated that, in other embodiments, different magnifications of the objective lens may be used (e.g. in a range of 1×-4× for DDM imaging mode and in a range of 5×-20× for Visual imaging mode). It will also be appreciated that, in other embodiments, different binning modes may be used for the DDM imaging mode and/or the visual imaging mode.

Where the context allows, embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic storage media; optical storage media; flash memory devices; electrical, optical, acoustical or other forms of propagated signals (e.g. carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc. and in doing that may cause actuators or other devices to interact with the physical world.

While specific embodiments of the invention have been described above, it will be appreciated that the invention may be practiced otherwise than as described. The descriptions above are intended to be illustrative, not limiting. Thus it will be apparent to one skilled in the art that modifications may be made to the invention as described without departing from the scope of the claims set out below.

1. A portable device for measuring at least one parameter of particles in solution, the portable device comprising:
a light source;
a camera comprising an imaging sensor for generating digital images;
an optical system comprising at least one objective lens and/or an objective and/or a lens and/or a combination of lenses,
and a sample holder, wherein a sample comprises the particles in solution;
wherein the imaging sensor and/or camera has a frame rate of greater than 100 frames per second.

2. The portable device according to claim 1, wherein the frame rate of greater than 100 frames per second is with an image size of at least 512×512 pixels (+/−5%).

3. The portable device according to claim 1, wherein the device is at least partially enclosed or enclosed in a housing.

4. The portable device according to claim 1, wherein the device is for characterising fluctuations of intensity in the images.

5. The portable device according to claim 1, wherein the at least one parameter may include motility of the particles, mean speed, concentration, size, amplitude of head movement, rate of diffusion and/or frequency of head movement.

6. The portable device according to claim 1, wherein the optical system and/or imaging sensor is configurable or configured such that a pixel size in the image is and/or is selectable from a range of 0.1 micron/pixel to 10.0 micron/pixel.

7. The portable device according to claim 1, wherein the pixel size in the image is substantially 0.86, 0.9, 1.7, 2, 2.1, 4.3 and/or 7 micron/pixel.

8. The portable device according to claim 1, wherein the imaging sensor comprises a pixel size in a range of 0.5 to 10 microns/pixel.

9. The portable device according to claim 1, wherein the device comprises a means for running in different binning or skipping modes.

10. The portable device according to claim 1, wherein the device comprises a means to heat, cool or maintain the temperature of the sample and/or the sample holder at a predetermined temperature.

11. The portable device according to claim 10, wherein the device comprises a heated stage configured to heat or maintain the temperature of the sample and/or sample holder and/or a plurality of channels of a sample slide at the predetermined temperature.

12. The portable device according to claim 11, wherein the heated stage comprises a plate that is heated to the predetermined temperature, a resistor or a plurality of resistors to heat the plate and a temperature sensor to measure the temperature of the plate.

13. The portable device according to claim 10, wherein the predetermined temperature at least one of: varies by only +/−0.1° C., +/−0.5° C. or +/−1° C.; is between ambient temperature and 50° C.; is in a range of 36-41° C., is in a range of 36-41° C. +/−0.1° C.; is in a range of 36-41° C. +/−0.5° C.; is in a range of 36-41° C. +/−1° C.; is substantially 36° C., 36° C. +/−0.1° C., 36° C. +/−0.5° C., 36° C. +/−1° C., 37° C., 37° C. +/−0.1° C., 37° C. +/−0.5° C., 37° C. +/−1° C., 37.5° C., 37.5° C. +/−0.1° C., 37.5° C. +/−0.5° C., 37.5° C. +/−1° C., 38° C., 38° C. +/−0.1° C., 38° C. +/−0.5° C., 38° C. +/−1° C., 39° C., 39° C. +/−0.1° C., 39° C. +/−0.5° C., 39° C. +/−1° C., 40° C., 40° C. +/−0.1° C., 40° C. +/−0.5° C., 40° C. +/−1° C., 41° C., 41° C. +/−0.1° C., 41° C. +/−0.5° C., and/or 41° C. +/−1° C.

14. The portable device according to claim 1, wherein the device comprises a processing unit for processing and/or being configured to process the digital images.

15. The portable device according to claim 14, wherein the processing unit comprises at least one pre-stored processing routine, the pre-stored processing routine for obtaining the at least one parameter, wherein the pre-stored processing routine is configurable by a user to analyse the power spectrum of the difference between pairs of the spatial Fourier transform of the digital images separated by a time delay over a range of time delay and spatial Fourier frequency, over all possible, or a selection of, pairs of Fourier images and/or over all possible, or a selection of, q values.

16. The portable device according to claim 15, wherein analysing the power spectrum of the difference between pairs of the spatial Fourier transform of the digital images separated by a time delay over a range of time delay and spatial Fourier frequency comprises:
calculating the differential image correlation function (DICF), i.e. calculating the spatial Fourier transform of the images and then calculating the power spectrum of the difference of pairs of the Fourier images over a range of accessible delay time tau (i.e. time difference between two selected images) and spatial frequency (q) provided by the Fourier transform of the images, over all possible, or a subsection of, pairs of Fourier images,
then averaging all resulting DICF which has the same delay time (tau) together, and
then performing a radial average for each q values yielding the final time-averaged and vector{q}-averaged DICF as a function of delay time tau and spatial frequency q, over all possible, or a subsection of, q values.

17. The portable device according to claim 14, wherein the processing unit is for carrying out and/or is configured to carry out Differential Dynamic Microscopy (DDM), over all pairs of images and q values or a subsection of all pairs of images and/or a subsection of all the q values, to obtain the at least one parameter.

18. The portable device according to claim 1, wherein the particles are micro-organisms.

19. The portable device according to claim 1, wherein the optical system comprises at least two objective lenses, wherein the at least two objective lenses have at least one different optical property.

20. The portable device according to claim 1, wherein the objective lens or lenses has at least one of: a focal length of 15 cm, a focal length of less than 15 cm, a magnification in a range of 1× to 4×, a magnification in a range of 5× to 10×, a magnification in a range of 5× to 20×, and/or a magnification in a range of 5× to 50×.

21. The portable device according to claim 1, wherein the optical system comprises a means for reflecting light from the objective lens to the imaging sensor.

22. The portable device according to claim 1, wherein the device is configurable and/or configured such that light from the light source is transmitted to the sample holder without undergoing refraction.

23. The portable device according to claim 1, wherein the sample holder is configured such that a pre-determined position or positions is or are selectable for a plurality of channels of a sample slide.

24. A method of measuring at least one parameter of particles in a portable device, the method comprising: providing a sample comprising particles in solution, introducing the sample into a sample holder in the portable device, generating digital images from an imaging sensor in a camera in the portable device, and recording the digital images at a frame rate of greater than 100 frames per second.

25. A system comprising: a portable device and a remote processing unit for measuring at least one parameter of particles in solution, the portable device comprising:
a light source;
a camera comprising an imaging sensor for generating digital images;
an optical system comprising at least one objective lens;
a sample holder, and
a means for transferring the digital images to the remote processing unit;
wherein the imaging sensor and/or camera has a frame rate of greater than 100 frames per second.
